(19) United States
(12) Patent Application Publication
(10) Pub. No.: US 2018/0240433 A1
(43) Pub. Date: Aug. 23, 2018

(54) SOURCE DRIVER, METHOD AND DISPLAY DEVICE

(71) Applicants: BOE TECHNOLOGY GROUP CO., LTD.; BEIJING BOE DISPLAY TECHNOLOGY CO., LTD.

(72) Inventors: Chenxi LIU, Beijing (CN); Shou LI, Beijing (CN); Chao ZHANG, Beijing (CN); Jian ZHANG, Beijing (CN)

(21) Appl. No.: 15/556,516

(22) PCT Filed: Feb. 17, 2017
(86) PCT No.: PCT/CN2017/073887

§ 371 Date: Sep. 7, 2017

(30) Foreign Application Priority Data
Jul. 13, 2016 (CN) 201610552190.7

(51) Int. Cl. G09G 3/36

(52) U.S. Cl. CPC G09G 3/3688; G09G 2340/16; G09G 3/3614

(57) ABSTRACT

A source driver, a method and a display device are provided. The source driver includes a data receiving circuit, a peak processing circuit, a control circuit, a digital-to-analog conversion circuit, and a driver. The data receiving circuit is configured to receive pixel data and a control timing signal; the peak processing circuit is configured to generate peak over-driving data according to the received pixel data; the control circuit is configured to control to sequentially output the peak over-driving data and the corresponding pixel data to the digital-to-analog conversion circuit according to the received control timing signal; the digital-to-analog conversion circuit is configured to receive the peak over-driving data and the pixel data, convert the peak over-driving data into a first driving signal, and convert the pixel data into a second driving signal; and the driver is configured to output the first driving signal and the second driving signal.

### TECHNICAL FIELD

Embodiments of the present disclosure relate to a source driver, a method and a display device.

### BACKGROUND

A thin film transistor liquid crystal display (TFT-LCD) display typically includes an array substrate, a color filter substrate, and a liquid crystal layer sandwiched therebetween. The array substrate includes an active display region including pixels arranged in an array, and may also include a source driver and a gate driver provided outside the active display region, the source driver and the gate driver are respectively connected with the pixels, to respectively provide data lines and gate lines in the active display region with data signals and scan signals, so as to drive the pixels to display. The source driver may include a source driver chip and wires electrically connected with the data lines.

### SUMMARY

At least an embodiment of the present disclosure provides a source driver, comprising a data receiving circuit, a peak processing circuit, a control circuit, a digital-to-analog conversion circuit, and a driver. The data receiving circuit is configured to receive pixel data and a control timing signal; the peak processing circuit is configured to generate peak over-driving data according to the received pixel data; the control circuit is configured to control to sequentially output the peak over-driving data and the corresponding pixel data to the digital-to-analog conversion circuit according to the received control timing signal; the digital-to-analog conversion circuit is configured to receive the peak over-driving data and the pixel data, convert the peak over-driving data into a first driving signal, and convert the pixel data into a second driving signal; and the driver is configured to output the first driving signal and the second driving signal.

For example, in an embodiment, the source driver further comprises a pixel data caching circuit and a peak data caching circuit, wherein the pixel data caching circuit is configured to store the pixel data; the peak data caching circuit is configured to store the peak over-driving data generated by the peak processing circuit; and the control circuit is configured to transmit control timing to the peak data caching circuit and the pixel data caching circuit, to respectively input the pixel data and the peak over-driving data stored into the digital-to-analog conversion circuit.

For example, in an embodiment, the peak processing circuit is configured to receive a scale value, compute products of the scale value and the pixel data, and take the products as the peak over-driving data corresponding to the pixel data.

For example, in an embodiment, the data receiving circuit is further configured to receive a first lookup table, the first lookup table including a pixel data compensation value; and the peak processing circuit is configured to query the first lookup table according to the pixel data, to obtain the pixel data compensation values corresponding to the pixel data, and obtain the peak over-driving data according to the pixel data compensation values.

For example, in an embodiment, the source driver further comprises a lookup table generating circuit, wherein, the lookup table generating circuit is configured to generate a first lookup table including compensation values according to the pixel data; and the peak processing circuit is configured to query the first lookup table according to the pixel data, to obtain the pixel data compensation values corresponding to the pixel data, and take the pixel data compensation values as the peak over-driving data.

For example, in an embodiment, the data receiving circuit is configured to receive a compensation period used for the peak over-driving data; and the driver is configured to transmit the first driving signal within the compensation period.

For example, in an embodiment, the source driver further comprises a compensation period setting circuit, wherein the compensation period setting circuit is configured to generate a compensation period used for the peak over-driving data; and the driver is configured to transmit the first driving signal within the compensation period.

For example, in an embodiment, the source driver further comprises a second lookup table generating circuit, wherein the second lookup table generating circuit is configured to generate a second lookup table, the second lookup table being used for storing compensation values and a compensation period corresponding to the compensation values; the peak processing circuit is further configured to query the second lookup table according to the pixel data, to obtain corresponding compensation values, and then obtain the peak over-driving data according to the corresponding compensation values; and the driver is further configured to transmit the first driving signal within the compensation period.

For example, in an embodiment, the data receiving circuit is further configured to receive a second lookup table, the second lookup table including pixel compensation values and a compensation period corresponding to the pixel compensation values; the peak processing circuit is further configured to query the second lookup table according to the pixel data, to obtain the corresponding pixel compensation values, and obtain the peak over-driving data according to the corresponding pixel compensation values; and the driver is further configured to transmit the first driving signal within the compensation period.

For example, in an embodiment, the peak processing circuit is further configured to determine the peak over-driving data, according to relationship between a reverse polarity applied to pixel data of a current row of a previous frame and a reverse polarity applied to pixel data of the current row of a current frame.

For example, in an embodiment, the peak processing circuit is further configured to determine the peak over-driving data and the corresponding compensation period, according to the relationship between a reverse polarity applied to pixel data of a current row of a previous frame and a reverse polarity applied to pixel data of the current row of a current frame.

For example, in an embodiment, if the reverse polarity applied to the pixel data of the current row of the previous frame is same as the reverse polarity applied to the pixel data of the current row of the current frame, then the peak processing circuit is configured to receive difference between the pixel data of the current row and pixel data of a previous row, and determine the peak over-driving data according to the difference.

For example, in an embodiment, if the reverse polarity applied to the pixel data of the current row of the previous frame is same as the reverse polarity applied to the pixel data of the current row of the current frame, then the peak processing circuit is configured to receive difference between the pixel data of the current row and pixel data of a previous row, and determine the peak over-driving data and the corresponding compensation period according to the difference.

At least an embodiment of the present disclosure provides a source driving method, comprising: receiving pixel data and then generating peak over-driving data according to the pixel data; sequentially outputting the peak over-driving data and the pixel data by two-stage control timing to perform digital-to-analog conversion respectively on the peak over-driving data and the pixel data, to obtain a first driving signal corresponding to the peak over-driving data and a second driving signal corresponding to the pixel data; and sequentially outputting the first driving signal and the second driving signal.

For example, in an embodiment, the source driving method further comprises: receiving a scale value. Generating of the peak over-driving data according to the pixel data includes: computing products of the scale value and the pixel data, and taking the products as the peak over-driving data corresponding to the pixel data.

For example, in an embodiment, the source driving method further comprises: receiving a first lookup table, the first lookup table being used for storing compensation values. Generating of the peak over-driving data according to the pixel data includes: querying the first lookup table according to the pixel data, to obtain pixel data compensation values respectively corresponding to the pixel data, and then obtaining the peak over-driving data according to the pixel data compensation values obtained through query.

For example, in an embodiment, the source driving method further comprises: generating a first lookup table including compensation values according to the pixel data, Generating of the peak over-driving data according to the pixel data includes: querying the first lookup table according to the pixel data, to obtain pixel data compensation values respectively corresponding to the pixel data, and taking the pixel data compensation values as the peak over-driving data.

For example, in an embodiment, the source driving method further comprises: receiving a compensation period used for the peak over-driving data; and outputting the first driving signal within the compensation period.

For example, in an embodiment, the source driving method further comprises: generating a compensation period used for the peak over-driving data; and outputting the first driving signal within the compensation period.

For example, in an embodiment, the source driving method further comprises: generating a second lookup table, the second lookup table being used for storing compensation values and a compensation period corresponding to the compensation values. Generating of the peak over-driving data according to the pixel data includes: querying the second lookup table according to the pixel data to obtain the corresponding compensation values, and obtaining the peak over-driving data according to the corresponding compensation values; and outputting the first driving signal within the compensation period.

For example, in an embodiment, the source driving method further comprises: receiving a second lookup table, the second lookup table including pixel compensation values and a compensation period corresponding to the pixel compensation value. Generating of the peak over-driving data according to the pixel data includes: querying the second lookup table according to the pixel data to obtain the corresponding pixel compensation values, and obtaining the peak over-driving data according to the corresponding pixel compensation values; and outputting the first driving signal within the compensation period.

For example, in an embodiment, generating of the peak over-driving data according to the pixel data includes: determining the peak over-driving data, according to relationship between a reverse polarity applied to pixel data of a current row of a previous frame and a reverse polarity applied to pixel data of the current row of a current frame.

For example, in an embodiment, generating of the peak over-driving data according to the pixel data includes: determining the peak over-driving data and the corresponding compensation period, according to relationship between a reverse polarity applied to pixel data of a current row of a previous frame and a reverse polarity applied to pixel data of the current row of a current frame.

For example, in an embodiment, if the reverse polarity applied to the pixel data of the current row of the previous frame is same as the reverse polarity applied to the pixel data of the current row of the current frame, then generating of the peak over-driving data according to the pixel data includes: receiving difference between the pixel data of the current row and pixel data of a previous row, and determining the peak over-driving data according to the difference.

For example, in an embodiment, if the reverse polarity applied to the pixel data of the current row of the previous frame is the same as the reverse polarity applied to the pixel data of the current row of the current frame, then generating of the peak over-driving data according to the pixel data includes: receiving difference between the pixel data of the current row and pixel data of a previous row, and determining the peak over-driving data and the corresponding compensation period according to the difference.

At least an embodiment of the present disclosure provides a display device, comprising: a display panel and a source driver signally connected with the display panel, wherein the source driver is any one of the above source drivers.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic diagram of a pixel including a driving device provided by an embodiment of the present disclosure;

FIG. 2A is a composition block diagram of a source driver provided by an embodiment of the present disclosure;

FIG. 2B is a composition block diagram of a source driver provided by another embodiment of the present disclosure;

FIG. 3 is a schematic diagram of a generation method of peak over-driving data provided by an embodiment of the present disclosure;

FIG. 4 is a charge/discharge comparison diagram of a pixel with peak over-driving and without peak over-driving provided by an embodiment of the present disclosure;

FIG. 5 is a flow chart of a source driving method provided by an embodiment of the present disclosure;

FIG. 6 is a schematic diagram of generating two driving signals for pixel data processing provided by an embodiment of the present disclosure; and

FIG. 7 is a block diagram of a display device provided by an embodiment of the present disclosure.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly.

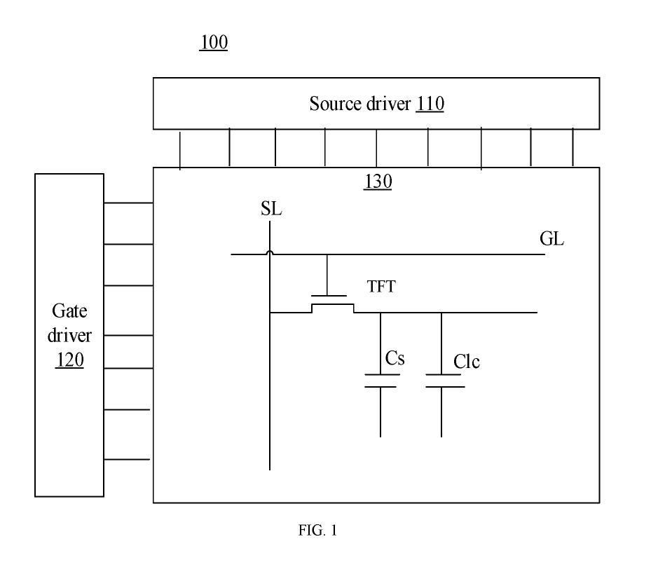

With reference to FIG. 1, a thin film transistor liquid crystal display (TFT-LCD) provided by an embodiment of the present disclosure includes a liquid crystal display panel 130, a source driver 110, and a gate driver 120. The liquid crystal display panel 130 includes, for example, a plurality of laterally extending gate lines GL and a plurality of longitudinally extending data lines SL, these gate lines GL and data lines SL intersecting with each other to define a pixel array including a plurality of pixels, each pixel being provided in a position where a corresponding gate line GL and a corresponding data line SL intersect with each other. The source driver 110 provided by the embodiment of the present disclosure may have a function of implementing peak over-driving.

In working, the gate driver 120 may, for example, scan respective gate lines GL of the liquid crystal display panel 130 line-by-line or every other line, and when a certain gate line GL is being scanned, the source driver 110 applies data signals (video signals) to the row of pixels corresponding to the gate line GL through the data lines SL. For example, each pixel includes a switching element (e.g., a thin film transistor (TFT)), a pixel electrode, a common electrode, etc., the pixel electrode and the common electrode constitute a liquid crystal capacitor (Clc) via a liquid crystal layer, in addition, the pixel may have a storage capacitor (Cs) formed therein, and the storage capacitor, for example, may be implemented by a storage electrode separately provided or implemented by the gate line, or the like. In each pixel, a gate electrode of the TFT is connected with the corresponding gate line GL, and a source electrode of the TFT is connected, for example, with the corresponding data line SL, and a drain electrode of the TFT is connected with the corresponding pixel electrode.

In an embodiment of the present disclosure, the source driver 110 has the circuit for implementing the peak over-driving function which is integrated therein, and may be used for executing a corresponding driving method, for example, a parameter controllable peak over-driving output function (e.g., the parameter may include a compensation period) is implemented through signal control, so that the source driver 110 has an improved output drive capability, which reduces the signal delay of the output signal, increases the charge current of a pixel, so that it is possible to reduce the effective charging time of the pixel and increase the charging effect thereof, and improve display quality and image quality of the display device.

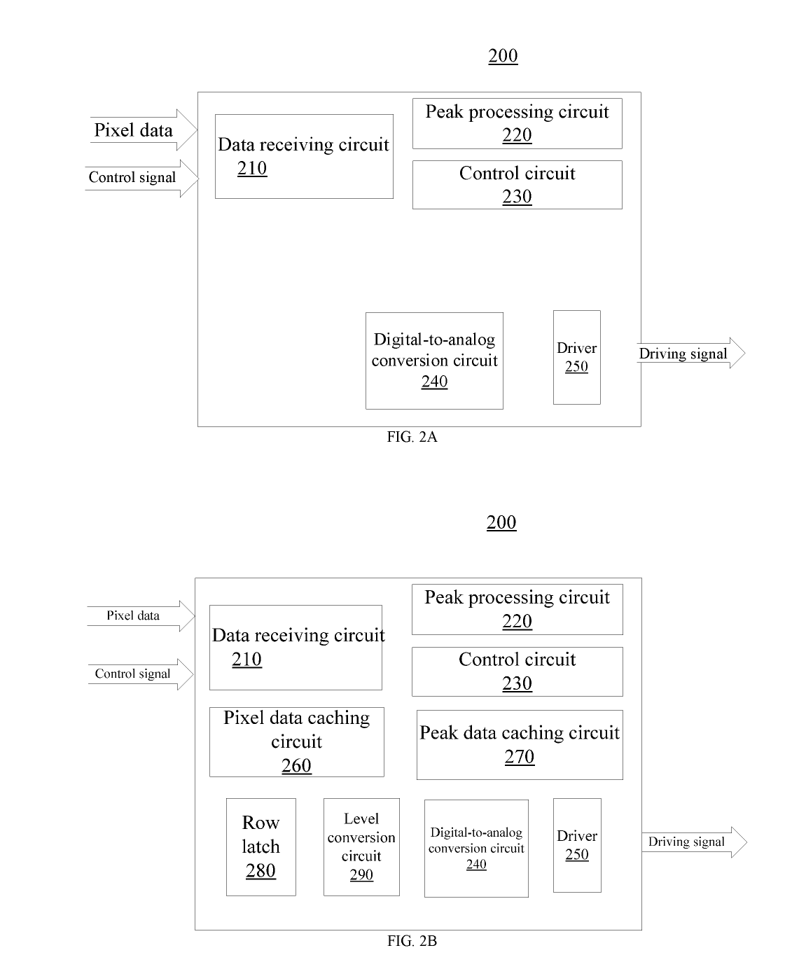

FIG. 2A is a source driver 200 provided by an embodiment of the present disclosure, comprising a data receiving circuit 210, a peak processing circuit 220, a control circuit 230, a digital-to-analog conversion circuit 240, and a driver 250.

The data receiving circuit 210 is configured to receive pixel data and a control timing signal. For example, the pixel data may include the pixel data corresponding to one frame of image or the pixel data of a certain row in one frame of image, the control timing signal may include a timing signal output by a timing control integrated circuit (TCON).

The peak processing circuit 220 is configured to generate peak over-driving data according to the received pixel data, and an algorithm for generating the peak over-driving data will be exemplified in an example below. For example, the peak data processing circuit 220 may also execute operations as follow: performing peak driving data processing computation according to the received timing control signal, the data signal, and the clock signal, and generating the peak over-driving data after the processing (i.e., data after compensation).

The control circuit 230 is configured to control to sequentially output the peak over-driving data and the corresponding pixel data to the digital-to-analog conversion circuit, according to the received control timing signal. For example, the control circuit 230 may receive a two-stage timing signal output from the timing control integrated circuit TCON to perform the above-described operation, and the control circuit 230 may also generate the two-stage timing signal by itself.

The digital-to-analog conversion circuit 240 is configured to receive the generated peak over-driving data and the pixel data, and it may convert the peak over-driving data into a first driving signal and convert the pixel data into a second driving signal. For example, a first-stage control timing controls to convert the peak over-driving data into an analog driving signal, while a second-stage control timing controls to convert the pixel data into an analog driving signal as well. The analog-to-digital conversion circuit 240 may be implemented in a variety of ways, for example, a decoding circuit. For example, the analog-to-digital conversion circuit 240 may include a decoder and a resistor string connected with the decoder, and there is only one switch between each node and the output of the resistor string. For another example, the analog-to-digital conversion circuit 240 may also be embodied in a mode of a binary switch tree, without a dedicated decoder. In the analog-to-digital conversion circuit 240, a switch corresponding to a negative polarity gray-scale voltage uses an NMOS transistor, and a switch corresponding to a positive polarity gray-scale voltage uses a PMOS transistor.

The driver 250 is configured to output the first driving signal and the second driving signal to the corresponding data lines in the active display region. For example, the driver 250 firstly outputs the first driving signal and then outputs the second driving signal, and further drives the pixels to display. For example, the driver 250 outputs an analog signal that may have been amplified. For example, the driver 250 may also include a two-stage operational amplifier structure, a first stage is a differential amplifier, and a second stage is an output operational amplifier.

In some embodiments, the data driver 210 may also receive the clock control signal CLK output by the timing control integrated circuit TCON, and may also receive a signal such as a lookup table.

In another embodiment, as shown in FIG. 2B, as compared with the embodiment as shown in FIG. 2A, the source driver 200 may further include a pixel data caching circuit 260, a peak data caching circuit 270, a row latch 280, and a level conversion circuit 290.

The peak data caching circuit 270 is configured to cache the peak over-driving data generated by the peak processing circuit 220. The pixel data caching circuit 260 is configured to cache the pixel data. For example, according to a specific operation method, the cached pixel data may be the pixel data of one frame, or the pixel data of a certain row of one frame, or include the pixel data of a certain row of a previous frame and the pixel data of the corresponding row of the present frame, etc. For example, when the peak over-driving data is generated with reference to historical data, the pixel data caching circuit 260 supplies the pixel data of the current row of the previous frame to the peak processing unit 220, so that the peak processing circuit 220 performs computation of the peak over-driving data according to the historical data that are supplied; when the peak processing circuit 220 completes the peak over-driving computation for the row of the present frame and transmits the derived peak over-driving data to the digital-to-analog conversion circuit 240, the pixel data caching circuit 260 then reads and stores the pixel data of the row of the present frame from a row latch 280, and then performs subsequent processing; when the digital-to-analog conversion circuit 240 completes digital-to-analog conversion processing for the peak over-driving data and outputs, the digital-to-analog conversion circuit 240 receives the pixel data of the row of the present frame from the pixel data caching circuit 260 under control of the control signal, to perform the digital-to-analog conversion processing and then outputs.

The control circuit 230 is used for generating or receiving a timing control signal (for example, a two-layer control signal). and the timing control signal is used for controlling the peak over-driving data and, together with an original pixel data, is sequentially subjected to both digital-to-analog conversion (DAC) and drive cache processing and then output. For example, the row latch 280 and the level conversion circuit 290 may be implemented as a digital circuit module, and the row latch 280 is used for storing the entire row of pixel data received by the source driver. For example, the source driver 200 may receive pixel data of the nth row while driving the (n−1)th row of pixels. For example, in a line-by-line scanning mode, after the row latch 280 stores the pixel data of the (n−1)th row, these pixel data are subjected to the processing by a subsequent functional circuit module, and then is output to the pixel of the (n−1)th row of the display panel, and at the same time, the row latch 280 starts receiving the pixel data of the nth row.

For example, the functional modules or circuits involving in generation of the first driving signal may include: the peak processing circuit 220, the control circuit 230, the peak data caching circuit 280, the digital-to-analog conversion circuit 240, and the driver 250, and these functional modules or circuits generate the first driving signal according to the input pixel data. For example, functional modules or circuits involving in generation of the second driving signal may include: the row latch 280, the level conversion circuit 290, the pixel data caching circuit 260, the digital-to-analog conversion circuit 240, and the driver 250, and these functional modules or circuits process the input pixel data and finally generate the second driving signal. The above-described pixel data caching circuit 260 and the peak data caching circuit 270 are controlled by the two-stage control signal of the control circuit 230. For example, under the control of the two-stage control signal of the control circuit 230, the peak over-driving data and the pixel data are sequentially subjected to digital-to-analog conversion and driving output.

In the embodiment of the present disclosure, the corresponding module such as the peak over-driving is integrated in the structure of the source driver, for performing the computation processing on the original data (i.e., unprocessed pixel data) received by a conventional source driver, and then generating a new peak driving data and a control signal. The control signal is used for sequentially performing digital-to-analog conversion, driving caching, and the like processing on the peak driving data and the original pixel data and for outputting then. There are a variety of modes of algorithms for generating the peak over-driving data, and for some exemplary algorithms, examples described below may be referred to.

### Implementation Mode One

The historical data of the current row of the previous frame is not referred to when the peak over-driving data is generated, and the peak over-driving data is generated by the way of computation according to the original pixel data of the current row of the current frame received.

### EXAMPLE 1

The peak processing circuit 220 provided by this example is configured to receive or generate a scale value, compute products of the scale value and the pixel data, and take the products as the peak over-driving data corresponding to the pixel data. For example, the peak processing circuit 220 at this time may include a multiplier, and the multiplier is configured for computing products of the input pixel data and a fixed scale value. For example, the peak processing circuit at this time may also implement multiplication operation with a software program. For example, the scale value may be a fixed value or a variation value.

### EXAMPLE 2

For example, the data receiving circuit 210 may further be configured to receive a first lookup table, and the first lookup table includes pixel data compensation values. In the example, the peak processing circuit 220 is configured to query the first lookup table according to the pixel data, to obtain the pixel data compensation values corresponding to the pixel data, and obtain the corresponding peak over-driving data according to the pixel data compensation values. For example, the peak processing circuit 220 takes the compensation values obtained through querying the first lookup table as the peak over-driving data, or perform computation with the compensation values obtained through querying the first lookup table and initial pixel data, to obtain the corresponding peak over-driving data.

For another example, the source driver 200 may also include a lookup table generating circuit of its own; this lookup table generating circuit is configured to generate, according to the pixel data, a first lookup table including the compensation values, so unlike the above-described example, the first lookup table is not received from the outside, but is internally generated. The peak processing circuit 220 is configured to query the first lookup table according to the pixel data, to obtain the pixel data compensation values corresponding to the pixel data, take the pixel data compensation value as the peak over-driving data, or perform computation with the compensation values obtained through querying the first lookup table and the initial pixel data to obtain the corresponding peak over-driving data.

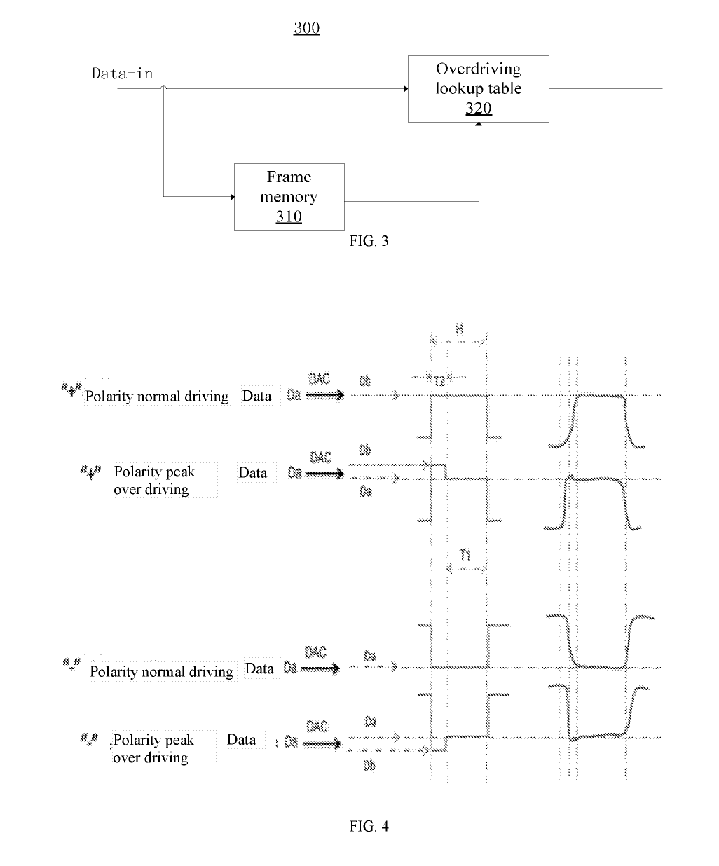

With reference to FIG. 3, the peak processing circuit 300 provided by the example includes a frame memory 310 and an overdriving lookup table 320, and the frame memory 310 and the overdriving lookup table 320 are coupled with each other. The frame memory 310 records image data of the previous frame, and outputs the image data of the previous frame into the overdriving lookup table 320. The overdriving lookup table 320, for example, is a two-dimensional table, which receives the image data of the previous frame from the frame memory 310 and the image data of a current frame (Data-in). The overdriving lookup table 320 generates the overdriving image data (i.e., the compensation values included in the first lookup table queried) corresponding to the image data, with the image data of the previous frame of the frame memory 310 and the image data of the current frame as index values. The values of the overdriving image data are overdriving values (i.e., the peak over-driving data) which are capable of increasing the deflection speeds of liquid crystal molecules.

For example, it is possible to provide the peak over-driving data to the pixels within a certain compensation period. For example, the data receiving circuit 210 is configured to receive the compensation period used for the peak over-driving data, and the driver 250 is configured to transmit the first driving signal within the compensation period so as to perform peak over-driving. Alternatively, the source driver 200 may further include a compensation period setting circuit, and the compensation period setting circuit is configured to generate the compensation period used for the peak over-driving data. At this time, the driver 250 is configured to transmit the first driving signal within the compensation period so as to perform the peak over-driving. For example, the length of the compensation period may be set to be a time period when the pixels are charged to a gray scale voltage corresponding to the pixel data.

Correspondingly, for example, the source driver 200 may include a second lookup table generating circuit of its own; the second lookup table generating circuit is configured to generate a second lookup table, and the second lookup table is used for storing compensation values and a compensation period corresponding to the compensation value. In the example, the peak processing circuit 220 is further configured to query the second lookup table according to the pixel data, to obtain corresponding compensation values, and then obtain the peak over-driving data according to the corresponding compensation values; and correspondingly, the driver 250 may further be configured to transmit the first driving signal within the compensation period. For example, the driver 250 transmits the first driving signal corresponding to the generated peak overdriving signal to the source electrode of a pixel within the compensation period, so as to further drive the pixel to complete charge display faster.

For another example, the data receiving circuit 210 may be further configured to receive the second lookup table, and the second lookup table includes pixel compensation values and compensation period corresponding to the pixel compensation value, and thus, unlike the above-described example, the second lookup table is not received from the outside, but is internally generated. In the example, the peak processing circuit 220 may be further configured to query the second lookup table according to the pixel data, to obtain the corresponding pixel compensation values, and obtain the peak over-driving data according to the corresponding pixel compensation values; and accordingly, in the example, the driver 250 is further configured to transmit the first driving signal within the compensation period. For a specific mode of querying the second lookup table, for example, the mode as described in FIG. 3 may be referred to.

### Implementation Mode Two

When the peak over-driving data is generated, the historical data may also be referred to. For example, the historical data may include: polarity or polarities of pixel data of the current row (i.e., a currently processed pixel row) of the previous frame or difference values between the pixel data of the current row of the previous frame and the pixel data of the current row of the current frame (i.e., a currently processed frame), and so on. For an exemplary implementation mode, please refer to a mode described in an example below.

### EXAMPLE 3

The peak processing circuit 220 provided by this example may further be configured to determine the peak over-driving data, according to the relationship between a reverse polarity or polarities applied to the pixel data of the current row of the previous frame and a reverse polarity or polarities applied to the pixel data of the current row of the current frame. For example, when the reverse polarity or polarities of the pixel data of the current row of the previous frame are the same as the reverse polarity or polarities of the pixel data of the current row of the current frame, the peak overdriving value generated is zero. When the reverse polarity or polarities of the pixel data of the current row of the previous frame are opposite to the reverse polarity or polarities of the pixel data of the current row of the current frame, peak over-driving data compensation is performed; and with respect to how the peak over-driving data at this time is computed, Example 1 or Example 2 as described above may be referred to, which will not be repeated here.

For another example, the peak processing circuit 220 provided by the example may further be configured to determine the peak over-driving data and the corresponding compensation period(s), according to the relationship between the reverse polarity or polarities applied to the pixel data of the current row of the previous frame and the reverse polarity or polarities applied to the pixel data of the current row of the current frame. For example, when the reverse polarity or polarities of the pixel data of the current row of the previous frame are opposite to the reverse polarity or polarities of the pixel data of the current row of the current frame, peak over-driving data compensation is performed; and with respect to how the peak over-driving data at this time is computed, Example 1 or Example 2 as described above may be referred to, which will not be repeated here.

For another example, when the peak overdriving value is being generated as provided by the example, the difference values between the pixel data of the current row of the previous frame and the pixel data of the current row of the current frame may be considered. For example, if the reverse polarity or polarities applied to the pixel data of the current row of the previous frame are the same as the reverse polarity or polarities applied to the pixel data of the current row of the current frame, then the peak processing circuit 220 is configured to receive the difference values between the pixel data of the current row and the pixel data of the current row, and determine the peak over-driving data according to the difference. For example, if the reverse polarity or polarities applied to the pixel data of the current row of the previous frame are the same as the reverse polarity or polarities applied to the pixel data of the current row of the current frame, then the peak processing circuit 220 is configured to receive the difference between the pixel data of the current row and the pixel data of the previous row, and determine the peak over-driving data and the corresponding compensation period according to the difference. For example, when it is determined that the pixel gray-scale data of the current row and the pixel gray-scale data of the previous row have the same polarity, the peak processing circuit 220 receives the pixel data of the current row of the previous frame and computes absolute values of the difference between the pixel data of the current row of the current frame and the pixel data of the current row of the previous frame, and at this time, the peak processing module 220 may be further configured to: take the compensation values obtained through querying the first lookup table or the second lookup table as the peak over-driving data, when the absolute values of the difference are greater than a set threshold. Alternatively, when it is determined that the pixel data of the current row of the current frame and the pixel data of the current row of the previous frame have opposite polarities, the peak processing module 220 is further configured to: take the compensation values obtained through querying the first lookup table or the second lookup table as the peak over-driving data.

With reference to FIG. 4, the diagram is a result comparison diagram of the pixel charged with the peak over-driving (corresponding to polarity peak over-driving in FIG. 4) provided by the embodiment of the present disclosure with the pixel charged without the peak over-driving provided by the embodiment of the present disclosure (corresponding to polarity normal driving in FIG. 4). Da is the pixel data received by the source driver, Db is the generated peak over-driving data, and T2 is a compensation period. H is a total time length for outputting a row of pixel data, T2 is a period length (i.e., the compensation period) of an analog level (i.e., the first driving signal) corresponding to the peak over-driving data, and T1 is a period length of an analog level (i.e., the second driving signal) corresponding to the pixel data received by the source driver. It can be known in conjunction with FIG. 4 and the description of the source driver that, as compared with the source driver in which the peak over-driving is not used, in the embodiment of the present disclosure, it is possible to generate data twice (the first driving signal and the second driving signal) within the time for one row, and output the same in two time periods; what is output at first is a level signal (i.e., the first driving signal) corresponding to peak driving data, and what is output then immediately in the second time period is a level signal (i.e., the second driving signal) corresponding to the pixel data, and a total time length for outputting the levels in two time periods is equal to the time for the source driver to output one row of data.

In addition, when the peak over-driving data is computed, the computation may be performed according to a scale value, and for example, after all pixel data values are received, compensation is performed according to a fixed scale value to generate the peak overdriving value, and it is also possible to perform computation according to the current pixel data value and also with reference to the lookup table (LUT) (for example, the first lookup table or the second lookup table as described above) to generate the peak over-driving data, and the lookup table may include the compensation value and the compensation period (i.e., the second lookup table) necessary for the compensation, and may also include only a compensation data value (i.e., the first lookup table), and advantages of this method include high accuracy, and ability to provide different compensation data for different pixels. For example, the above-described compensation period may be set individually according to the total output time of one row of data.

For example, when algorithm processing is performed further on the pixel data received by the source driver again, the amount of the compensation peak data for the original pixel data may be queried and computed according to the first lookup table and the second lookup table as described above. The values included in the lookup table may be determined according to characteristics of the display, for example, the timing control integrated circuit TCON or a driving chip may perform data transmission or data configuration to obtain the compensation values included in the lookup table when starting up.

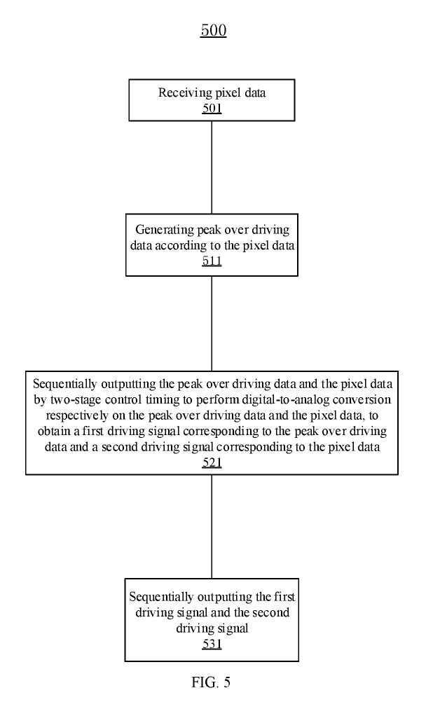

As shown in FIG. 5, an embodiment of the present disclosure provides a source driving method 500, and the method comprises the following operations:

Step 501: receiving pixel data;

Step 511: generating peak over-driving data according to the pixel data;

Step 521: sequentially outputting the peak over-driving data and the pixel data by two-stage control timing to perform digital-to-analog conversion respectively on the peak over-driving data and the pixel data, to obtain a first driving signal corresponding to the peak over-driving data and a second driving signal corresponding to the pixel data; and

Step 531: sequentially outputting the first driving signal and the second driving signal.

In some embodiments, step 511 may further include: receiving a scale value; computing products of the scale value and the pixel data, and taking the products as the peak over-driving data corresponding to the pixel data.

In some embodiments, step 511 may further include: receiving a first lookup table, the first lookup table being used for storing a compensation value(s); querying the first lookup table according to the pixel data, to obtain pixel data compensation values respectively corresponding to the pixel data, and then obtaining the peak over-driving data according to the pixel data compensation values obtained through query.

In some embodiments, step 511 may further include: generating the first lookup table including the compensation value according to the pixel data; querying the first lookup table according to the pixel data, to obtain pixel data compensation values respectively corresponding to the pixel data, and taking the pixel data compensation value as the peak over-driving data.

In some embodiments, step 511 may further include: receiving compensation period used for the peak over-driving data; and step 531 includes: outputting the first driving signal within the compensation period.

In some embodiments, step 511 may further include: generating the compensation period used for the peak over-driving data; and step 531 is: outputting the first driving signal within the compensation period.

In some embodiments, step 511 may further include: generating a second lookup table, the second lookup table being used for storing compensation values and the compensation period corresponding to the compensation values; querying the second lookup table according to the pixel data to obtain the corresponding compensation values, and obtaining the peak over-driving data according to the corresponding compensation values; and step 531 includes: outputting the first driving signal within the compensation period.

In some embodiments, step 511 may further include: receiving the second lookup table, the second lookup table including pixel compensation values and a compensation period corresponding to the pixel compensation values; querying the second lookup table according to pixel data to obtain the corresponding pixel compensation values, and obtaining the peak over-driving data according to the corresponding pixel compensation values; and step 531 includes: outputting the first driving signal within the compensation period.

In some embodiments, step 511 may further include: determining the peak over-driving data, according to relationship between a reverse polarity or polarities applied to the pixel data of the current row of the previous frame and a reverse polarity or polarities applied to the pixel data of the current row of the current frame.

In some embodiments, step 511 may further include: determining the peak over-driving data and the corresponding compensation period, according to relationship between a reverse polarity or polarities applied to the pixel data of the current row of the previous frame and a reverse polarity or polarities applied to the pixel data of the current row of the current frame.

In some embodiments, step 511 may further include: if the reverse polarity or polarities applied to the pixel data of the current row of the previous frame is the same as the reverse polarity or polarities applied to the pixel data of the current row of the current frame, then the step of generating peak over-driving data according to the pixel data includes: receiving difference between the pixel data of the current row and the pixel data of the previous row, and determining the peak over-driving data according to the difference.

In some embodiments, step 511 may further include: if the reverse polarity or polarities applied to the pixel data of the current row of the previous frame is the same as the reverse polarity applied to the pixel data of the current row of the current frame, then the step of generating peak over-driving data according to the pixel data includes: receiving difference between the pixel data of the current row and the pixel data of the previous row, and determining the peak over-driving data and the corresponding compensation period according to the difference.

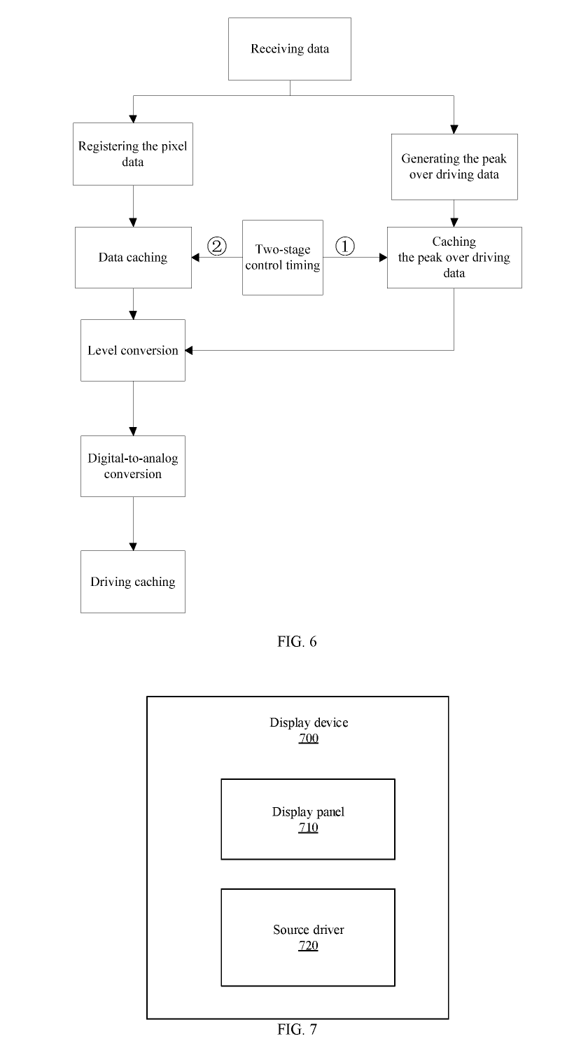

FIG. 6 is a flow chart of a source driving method provided by an embodiment of the present disclosure. As shown in the diagram, the method may comprise: firstly, receiving data, the data including pixel data. In some embodiments, the data further includes a lookup table, a timing control signal or a polarity reversal signal. The pixel data is used for generate a second driving signal on the one hand, and used for generating the peak over-driving data by a peak processing circuit (with reference to FIG. 2A or FIG. 2B) on the other hand.

Then, two operations below are performed on the received pixel data. Operation one: storing the received pixel data by means of a data register (which may be stored with the row latch shown in FIG. 2B), and then inputting the pixel data from the data register to the data caching for caching. Operation two: generating the peak over-driving data according to the received pixel data (the peak over-driving data may be obtained by computation by means of the peak processing circuit), and caching the generated peak over-driving data (the peak data cache 270 whose video is odd-even in FIG. 2B may be used); the above-described Examples 1-3 may be referred to for an algorithm for generating the peak over-driving data.

Next, two-stage control timing is generated or received, the peak over-driving data generated under controlling of the two-stage control timing and the pixel data cached by the row latch (with reference to FIG. 6, \textcircled{1} represents a first-stage control timing, and \textcircled{2} represents a second-stage control timing) may be sequentially subjected to level conversion processing (the step is, however, not indispensable) and analog-to-digital conversion processing, to obtain the first driving signal corresponding to the peak over-driving data and the second driving signal corresponding to the pixel data. Finally, the first driving signal and the second driving signal are sequentially output to a pixel source.

As shown in FIG. 7, an embodiment of the present disclosure provides a display device 700, comprising: a display panel 710 and a source driver 720 signally connected with the display panel. The source driver 720 may be any one of the source drivers 200 according to the above-described embodiments. In addition, the source driver 720 may be provided on the display panel 710 in a form of a tape carrier package (TCP) mode or a Chip On Glass (COG) mode.

Advantages of the source driver 110 provided by the embodiments of the present disclosure may include at least one of:

First, it is possible to implement peak over-driving output in a case where a timing control integrated circuit TCON end signal is normally received, which will not increase data transmission load and data transmission frequency on the timing control integrated circuit TCON end;

Second, it has a good adjustable peak over-driving output effect, to further optimize output capacity of a source drive integrated circuit (IC), and reduce climbing delay time of the signal output by the source driver;

Third, it can increase charge current of data lines, so as to ensure a more adequate pixel charge rate, and improve a picture quality and picture display effect of a liquid crystal display.

Drawings of the embodiments of the present disclosure only refer to structures related with the embodiments of the present disclosure, and other structures may refer to general design. Without conflict, the embodiments of the present disclosure and features in the embodiments may be combined with each other.

The foregoing embodiments merely are specific implementation modes of the present disclosure, but a protection scope of the present disclosure is not limited thereto, changes or replacements easily conceived by any skilled in art within the technical scope disclosed by the present disclosure should be covered by the protection scope of the present disclosure. Therefore, the protection scope of the present disclosure is determined by a protection scope of claims.

The application claims priority to the Chinese patent application No. 201610552190.7, filed Jul. 13, 2016, the entire disclosure of which is incorporated herein by reference as part of the present application.

1. A source driver, comprising a data receiving circuit, a peak processing circuit, a control circuit, a digital-to-analog conversion circuit, and a driver, wherein,
the data receiving circuit is configured to receive pixel data and a control timing signal;
the peak processing circuit is configured to generate peak over-driving data according to the received pixel data;
the control circuit is configured to control to sequentially output the peak over-driving data and the corresponding pixel data to the digital-to-analog conversion circuit according to the received control timing signal;
the digital-to-analog conversion circuit is configured to receive the peak over-driving data and the pixel data, convert the peak over-driving data into a first driving signal, and convert the pixel data into a second driving signal; and
the driver is configured to output the first driving signal and the second driving signal.

2. The source driver according to claim 1, further comprising a pixel data caching circuit and a peak data caching circuit, wherein,
the pixel data caching circuit is configured to store the pixel data;
the peak data caching circuit is configured to store the peak over-driving data generated by the peak processing circuit; and
the control circuit is configured to transmit control timing to the peak data caching circuit and the pixel data caching circuit, to respectively input the pixel data and the peak over-driving data stored into the digital-to-analog conversion circuit.

3. The source driver according to claim 1, wherein,
the peak processing circuit is configured to receive a scale value, compute products of the scale value and the pixel data, and take the products as the peak over-driving data corresponding to the pixel data.

4. The source driver according to claim 1, wherein,
the data receiving circuit is further configured to receive a first lookup table, the first lookup table comprising a pixel data compensation value; and
the peak processing circuit is configured to query the first lookup table according to the pixel data, to obtain the pixel data compensation values corresponding to the pixel data, and obtain the peak over-driving data according to the pixel data compensation values.

5. The source driver according to claim 1, further comprising a lookup table generating circuit, wherein, the lookup table generating circuit is configured to generate a first lookup table comprising compensation values according to the pixel data; and
the peak processing circuit is configured to query the first lookup table according to the pixel data, to obtain the pixel data compensation values corresponding to the pixel data, and take the pixel data compensation values as the peak over-driving data.

6. The source driver according to claim 4, wherein,
the data receiving circuit is configured to receive a compensation period used for the peak over-driving data; and
the driver is configured to transmit the first driving signal within the compensation period.

7. The source driver according to claim 4, further comprising a compensation period setting circuit, wherein,
the compensation period setting circuit is configured to generate a compensation period used for the peak over-driving data; and
the driver is configured to transmit the first driving signal within the compensation period.

8. The source driver according to claim 1, further comprising a second lookup table generating circuit, wherein,
the second lookup table generating circuit is configured to generate a second lookup table, the second lookup table being used for storing compensation values and a compensation period corresponding to the compensation values;
the peak processing circuit is further configured to query the second lookup table according to the pixel data, to obtain corresponding compensation values, and then obtain the peak over-driving data according to the corresponding compensation values; and
the driver is further configured to transmit the first driving signal within the compensation period.

9. The source driver according to claim 1, wherein,
the data receiving circuit is further configured to receive a second lookup table, the second lookup table comprising pixel compensation values and a compensation period corresponding to the pixel compensation values;
the peak processing circuit is further configured to query the second lookup table according to the pixel data, to obtain the corresponding pixel compensation values, and obtain the peak over-driving data according to the corresponding pixel compensation values; and
the driver is further configured to transmit the first driving signal within the compensation period.

10. The source driver according to claim 4, wherein,
the peak processing circuit is further configured to determine the peak over-driving data, according to relationship between a reverse polarity applied to pixel data of a current row of a previous frame and a reverse polarity applied to pixel data of the current row of a current frame.

11. The source driver according to claim 8, wherein,
the peak processing circuit is further configured to determine the peak over-driving data and the corresponding compensation period, according to the relationship between a reverse polarity applied to pixel data of a current row of a previous frame and a reverse polarity applied to pixel data of the current row of a current frame.

12. The source driver according to claim 10, wherein,
if the reverse polarity applied to the pixel data of the current row of the previous frame is same as the reverse polarity applied to the pixel data of the current row of the current frame, then the peak processing circuit is configured to receive difference between the pixel data of the current row and pixel data of a previous row, and determine the peak over-driving data according to the difference.

13. The source driver according to claim 11, wherein,
if the reverse polarity applied to the pixel data of the current row of the previous frame is same as the reverse polarity applied to the pixel data of the current row of the current frame, then the peak processing circuit is configured to receive difference between the pixel data of the current row and pixel data of a previous row, and determine the peak over-driving data and the corresponding compensation period according to the difference.

14. A source driving method, comprising:
receiving pixel data and then generating peak over-driving data according to the pixel data;
sequentially outputting the peak over-driving data and the pixel data by two-stage control timing to perform digital-to-analog conversion respectively on the peak over-driving data and the pixel data, to obtain a first driving signal corresponding to the peak over-driving data and a second driving signal corresponding to the pixel data; and
sequentially outputting the first driving signal and the second driving signal.

15. The source driving method according to claim 14, further comprising:
receiving a scale value;
wherein generating of the peak over-driving data according to the pixel data comprises:
computing products of the scale value and the pixel data, and
taking the products as the peak over-driving data corresponding to the pixel data.

16. The source driving method according to claim 14, further comprising:
receiving a first lookup table, the first lookup table being used for storing compensation values;
wherein generating of the peak over-driving data according to the pixel data comprises:
querying the first lookup table according to the pixel data, to obtain pixel data compensation values respectively corresponding to the pixel data, and
then obtaining the peak over-driving data according to the pixel data compensation values obtained through query.

17. The source driving method according to claim 14, further comprising:
generating a first lookup table comprising compensation values according to the pixel data;
wherein generating of the peak over-driving data according to the pixel data comprises:
querying the first lookup table according to the pixel data, to obtain pixel data compensation values respectively corresponding to the pixel data, and
taking the pixel data compensation values as the peak over-driving data.

18.-19. (canceled)

20. The source driving method according to claim 14, further comprising:
generating a second lookup table, the second lookup table being used for storing compensation values and a compensation period corresponding to the compensation values;
wherein generating of the peak over-driving data according to the pixel data comprises:
querying the second lookup table according to the pixel data to obtain the corresponding compensation values, and obtaining the peak over-driving data according to the corresponding compensation values; and
outputting the first driving signal within the compensation period.

21. The source driving method according to claim 14, further comprising:
receiving a second lookup table, the second lookup table comprising pixel compensation values and a compensation period corresponding to the pixel compensation value;
wherein generating of the peak over-driving data according to the pixel data comprises:
querying the second lookup table according to the pixel data to obtain the corresponding pixel compensation values, and obtaining the peak over-driving data according to the corresponding pixel compensation values; and
outputting the first driving signal within the compensation period.

22.-25. (canceled)

26. A display device, comprising:
a display panel; and
a source driver signally connected with the display panel, wherein the source driver is the source driver according to claim 1.
